(19) United States
(12) Patent Application Publication
(10) Pub. No.: US 2022/0355627 A1
(43) Pub. Date: Nov. 10, 2022

(54) Monitoring Towable Asset Movement with TPMS

(71) Applicant: PHILLIPS CONNECT TECHNOLOGIES LLC, Santa Fe Springs, CA (US)

(72) Inventor: Gil WINOGRAD, Santa Fe Springs, CA (US)

(21) Appl. No.: 17/737,900

(22) Filed: May 5, 2022

Related U.S. Application Data
(60) Provisional application No. 63/184,718, filed on May 5, 2021.

(51) Int. Cl. B60C 23/04

(52) U.S. Cl. CPC B60C 23/0459; B60C 23/0454; B60C 23/0479; B60C 23/0488

(57) ABSTRACT

A TPMS sensor for towable asset is configured to not only report a tire pressure but also whether the tire has moved. A telematics transceiver may then maintain a GNSS receiver in a sleep mode of operation (e.g., powered down) while the TPMS sensor does not report any motion.

### CROSS-REFERENCE TO RELATED APPLICATIONS

This application claims the benefit of U.S. Provisional Application No. 63/184,718, filed May 5, 2021, the contents of which are hereby incorporated by reference in their entirety.

### TECHNICAL FIELD

The present invention relates to telematics, and more particularly to monitoring towable asset movement with a tire pressure monitoring system (TPMS).

### BACKGROUND

Telematics is commonly utilized in commercial trucking fleets. For example, each trailer (or more generally, a towable asset) may be configured with a telematics transceiver that communicates through a wireless link with a remote server. Through the reporting by the telematics transceiver, a user may monitor various systems in the towable asset such as tire pressure monitoring system (TPMS) sensors, cargo sensors, cameras, gladhand connector status, lamp status such as the brake lights, and so on. In addition, the telematics transceiver will typically include a satellite-based positioning system receiver such as a global navigation satellite system (GNSS) receiver to monitor the location of the towable asset.

While the towable asset is disconnected from a tractor, power for the telematics transceiver is typically supplied by a battery. Although the towable asset may include solar panels for recharging the battery, it is not unusual for warehouses and other areas in which towable assets are parked to shade the towable asset such that the battery recharging is limited. Power consumption of the telematics transceiver is thus an area of concern so that the battery is not discharged.

### SUMMARY

A towable asset monitoring system is provided that includes: a tire pressure monitoring system (TPMS) sensor configured to monitor a tire pressure of a monitored tire, the TPMS sensor including an accelerometer configured to detect motion of the monitored tire, wherein the TPMS sensor is configured to transmit a message for reporting the tire pressure and for reporting a detected motion of the monitored tire; and a telematics transceiver configured to receive the message, the telematics transceiver further including a GNSS receiver, wherein the telematics transceiver is configured to maintain the GNSS receiver in a sleep mode of operation responsive to a reporting of no detected motion of the monitored tire in the message.

A telematics method is provided that includes: in a TPMS sensor, monitoring a tire pressure and movement or lack of movement of a tire for a towable asset; reporting the tire pressure and the movement or lack of movement to a telematics transceiver in the towable asset; maintaining a GNSS receiver in a sleep mode of operation responsive to the reporting of the lack of movement; and transmitting a previously-determined location of the towable asset from telematics transceiver to a remote server.

These and additional advantageous features of the disclosed embodiments may be better appreciated through a consideration of the following detailed description.

### BRIEF DESCRIPTION OF THE DRAWINGS

FIG. 1 is a diagram of a towable asset telematics system in accordance with an aspect of the disclosure.

Embodiments of the present disclosure and their advantages are best understood by referring to the detailed description that follows. It should be appreciated that like reference numerals are used to identify like elements illustrated in one or more of the FIGURES.

### DETAILED DESCRIPTION

It is conventional for a telematics transceiver for a towable asset (e.g., a trailer, a flat-bed, etc.) to include a satellite-based positioning system such as a GNSS receiver. The telematics transceiver may then report the location of the towable asset as sensed through the GNSS receiver. After the GNSS receiver has sensed the towable asset location, it may then be put into a sleep mode of operation (e.g., being powered down) to limit power consumption. But the power consumption for the GNSS receiver when awakened to perform a location determination may be a factor in draining the battery for the telematics transceiver before it may be recharged through a connection to the tractor or to a solar panel. For example, it may be a system requirement that the telematics transceiver report the towable asset location periodically. The continued use of the GNSS receiver may then deplete the battery charge, particularly in shaded locations in which the solar panel cannot sufficiently recharge the transceiver's battery. In addition, note that there is an inherent tolerance to a GNSS location measurement. For example, a GNSS receiver's location determination may change by several meters from one location determination to another despite the towable asset remaining stationary. The reporting of the towable asset location will thus undesirably vary over time even though the towable asset has remained stationary.

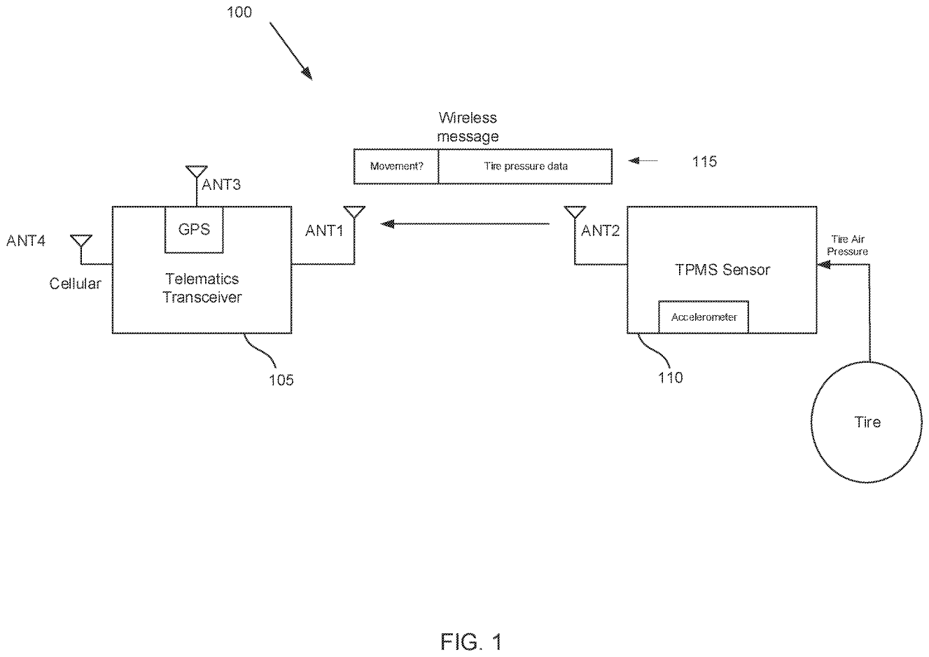

To address this power consumption issue and provide additional benefits, a telematics system for a towable asset is provided in which a TPMS sensor not only reports the tire pressure of a monitored tire but also reports whether the TPMS sensor has detected motion. A towable asset with an example telematics system 100 is shown in FIG. 1. A telematics transceiver 105 includes an antenna ANT1 for receiving a wireless message 115 from a TPMS sensor 110 as broadcast through an antenna ANT2. Wireless message 115 may be a WiFi message, a Bluetooth message, or another suitable wireless message protocol. As is conventional, wireless message 115 includes a field for the tire pressure data from a monitored tire. But TPMS sensor 110 also includes a movement sensor such as an accelerometer. TPMS sensor 110 may thus be further configured to report to the telematics transceiver 105 through a movement field in wireless message 115 whether the accelerometer has detected motion. In one embodiment, the movement field may be a single flag bit that is asserted (a binary true value) in case of motion being detected and is de-asserted (a binary false value).

In alternative implementations, the report of sensor motion may be indirect as compared to the use of a movement field. For example, TPMS sensor 110 may be configured to vary the rate at which wireless message 115 is reported depending upon whether motion is sensed or not. Telematics transceiver 105 could then compare the rate or frequency it receives wireless message 115 to a threshold value to determine whether motion has been detected.

Telematics transceiver 105 is configured in one mode of operation to maintain its GNSS receiver in a sleep mode of operation (e.g., being powered down) so long as the wireless message 115 indicates that the accelerometer in TPMS sensor 110 has not detected any motion. The GNSS receiver continues to monitor the position of the towable asset while the wireless message 115 indicates that motion is detected. There will thus be previously detected position by the GNSS receiver that occurs just prior to the wireless message 115 indicating that the towable asset is stationary. While the towable asset continues to be stationary, telematics transceiver may periodically upload the previously detected position. This is quite advantageous as the telematics transceiver 105 may periodically report its position such as through an antenna (ANT4) for a cellular link using the previously determined location without requiring action by the GNSS receiver. The GNSS receiver is thus no longer needlessly awakened to determine a location of a stationary towable asset. In addition, the tolerance of the GNSS receiver that would otherwise produce random variations in the reported location is suppressed since the same previously determined location may be reported by telematics transceiver 105 so long as no motion has been detected. In contrast, should telematics transceiver 105 occasionally awaken the GNSS receiver to obtain a location determination as would be conventional despite the towable asset remaining stationary, the resulting reported location will tend to vary by whatever the measurement tolerance is (e.g, +/− several meters) for the GNSS receiver.

Should the wireless message 115 indicate that the towable asset has been moved, telematics transceiver 105 may then transition the GNSS receiver to an active mode of operation to sample GNSS satellite signals as received through an antenna (ANT3) so that a new location determination may be reported. Note that the various antennas for the telematics transceiver 105 may be combined in alternative implementations. The resulting determination of motion by TPMS sensor 110 is advantageous as opposed to integrating an accelerometer in telematics transceiver 105. For example, it is common for a towable asset such as a trailer to be subjected to considerable vibration as a forklift is operated to remove or load freight. In addition, other trucks may be relatively close by that also cause vibration. A telematics-transceiver-integrated accelerometer may thus mistakenly detect motion such that the GNSS receiver is needlessly awakened to perform a location determination due to such vibration. Although the tires of a towable asset are also subject to vibration, the rotational movement of a tire is readily distinguished from vibration by the TPMS-sensor-located accelerometer. In contrast, the linear movement of telematics transceiver 105 as a towable asset is docked or removed from a loading dock is more readily confused with vibration.

In alternative embodiments, the movement field may include a measurement by the accelerometer of the tire's rotational speed as opposed to just a one-bit flag. Telematics transceiver 105 may then integrate the tire rotational data with other measurements to improve accuracy of operation. In addition, the TPMS sensor 110 and telematics transceiver 105 may be coupled together through a wired connection so that wireless message 115 would instead be a wired message.

As those of some skill in this art will by now appreciate and depending on the particular application at hand, many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

We claim:

1. A telematics system for a towable asset, comprising:
a tire pressure monitoring system (TPMS) sensor configured to monitor a tire pressure of a monitored tire, the TPMS sensor including an accelerometer configured to detect motion of the monitored tire, wherein the TPMS sensor is configured to transmit a message for reporting the tire pressure and for reporting a detected motion of the monitored tire; and
a telematics transceiver configured to receive the message, the telematics transceiver further including a GNSS receiver, wherein the telematics transceiver is configured to maintain the GNSS receiver in a sleep mode of operation responsive to a reporting of no detected motion of the monitored tire in the message.

2. The telematics system of claim 1, wherein the TPMS sensor is further configured to transmit the message as a wireless message, and wherein the telematics transceiver is further configured to receive the wireless message.

3. The telematics system of claim 2, wherein the wireless message is a Bluetooth message.

4. The telematics system of claim 2, wherein the wireless message is a WiFi message.

5. The telematics system of claim 1, wherein the telematics transceiver is further configured to awaken the GNSS receiver to perform a location determination responsive to the reporting of the detected motion of the monitored tire.

6. The telematics system of claim 1, wherein the telematics transceiver is further configured to transmit a previously determined location from the GNSS receiver to a remote server responsive to the reporting of no detected motion of the monitored tire.

7. The telematics system of claim 5, wherein the reporting of the detected motion of the monitored tire comprises a single bit message.

8. The telematics system of claim 5, wherein the reporting of the detected motion includes a tire rotation speed of the monitored tire.

9. The telematics system of claim 1, wherein the message includes a motion field having a binary flag that is asserted to report the detected motion of the monitored tire.

10. A telematics method, comprising:
in a TPMS sensor, monitoring a pressure of a monitored tire of a towable asset and monitoring a motion of the monitored tire;
transmitting a message from the TPMS sensor to a telematics transceiver in the towable asset to report the pressure of the monitored tire and the motion of the monitored tire from the TPMS sensor;
maintaining a GNSS receiver in the telematics transceiver in a sleep mode of operation responsive to the message reporting that the monitored tire is stationary; and
transmitting a previously determined location of the towable asset by the GNSS receiver from the telematics transceiver to a remote server while the GNSS receiver is in the sleep mode of operation.

11. The telematics method of claim 10, further comprising:
transitioning the GNSS receiver from the sleep mode of operation to an active mode of operation responsive to the message reporting that the monitored tire is moving;
after transitioning the GNSS receiver to the active mode of operation, determining a new location of the towable asset using the GNSS receiver; and
transmitting the new location from the telematics transceiver to the remove server.

12. The telematics method of claim 10, wherein the transmitting the message from the TPMS sensor to the telematics transceiver comprises asserting a motion field in the message responsive to the TPMS sensor determining that the monitored tire is not stationary.

13. The telematics method of claim 10, wherein transmitting the message from the TPMS sensor to the telematics transceiver comprises de-asserting a motion filed in the message responsive to the TPMS sensor determining that the monitored tire is stationary.

14. The telematics method of claim 10, wherein transmitting the message comprises transmitting a WiFi message.

15. The telematics method of claim 10, wherein transmitting the message comprises transmitting a wired message.

16. The telematics method of claim 10, wherein transmitting the message comprises transmitting a Bluetooth message.
